(19) United States
(12) Patent Application Publication
(10) Pub. No.: US 2014/0364987 A1
(43) Pub. Date: Dec. 11, 2014

(54) OPERATING PLAN FORMULATION SUPPORT SYSTEM AND METHOD

(71) Applicant: Hitachi, Ltd., Tokyo (JP)

(72) Inventor: Hiroaki SHIKANO, Tokyo (JP)

(73) Assignee: Hitachi, Ltd., Tokyo (JP)

(21) Appl. No.: 14/299,575

(22) Filed: Jun. 9, 2014

(30) Foreign Application Priority Data
Jun. 11, 2013 (JP) 2013-122646

(51) Int. Cl. G05B 19/048

(52) U.S. Cl. CPC G05B 19/048; G05B 2219/23103
USPC 700/111

(57) ABSTRACT

An operation item in which a period of manipulation by an operator makes up a dominant part and some of the procedures of another operation item in which a period of system actions makes up a dominant part are allocated in parallel to enhance the efficiency of operation. Information that discriminates whether each manipulating procedure of an operation item is dominated by a period of manipulation by an operator or by a working period of a system is stored into an operating procedure DB on a storage. Processing of operation allocation by an operation management server that supports allocation of operation items to operators utilizes the distinguishing information to multiply allocate some procedures of another operation item defined in an operation item management DB, and the already allocated procedures are presented to the operator at the operator's terminal.

### CLAIM OF PRIORITY

The present application claims priority from Japanese application serial no. JP2013-122646, filed on Jun. 11, 2013, the content of which is hereby incorporated by reference into this application.

### TECHNICAL FIELD

The present invention relates to an operating plan formulation support technique by which support is provided in allocating and presenting to operators manipulating procedures for servers and other equipment at a data center or the like.

### BACKGROUND

Along with the fast development and dissemination of communication networks, cloud computing that realizes utilization of information via a network is in rapidly expanding use. As a result, the cost of its operation management is posing a major problem as the scale of data centers to store information systems is growing and its operation bases are being developed in global dimensions. For instance, in the operation management of data centers, the operations have to cover a broad range including the confirmation, restart and batch processing of the working state of facilities including a vast number of servers and network equipment, backup of disks, responses to abnormalities and reporting on such operations to customers, and furthermore the objects of required management include not only servers and other IT equipment but also air conditions and power sources, security monitoring and watching of personnel coming in and out, with the result that enhancing the efficiency of these operations is now indispensable.

To address this problem, such attempts have been made as integration of system operation management using specialized middleware intended to reduce the operation management cost, standardization of the operation management process using Information Technology Infrastructure Library (ITIL), automation of operational procedures by Run Book Automation and collective management of constituent information elements by Configuration Management Database (CMDB). These tools and management techniques do help realize labor saving in manipulating or managing equipment, but, before they are put into an operational phase, the particulars of manipulation or management of the equipment to which they are applied should be designed as operating procedures. So far, designing of operating procedures has been mainly done manually by the operation manager using spreadsheet software or CAD software as operating procedure documents to help understand the pertinent system configuration and learn routine operation items needed for working the system. However, manual preparation of operating procedure documents is an extremely troublesome job. To make preparation of such operating procedure documents more efficiently, there is a technique by which common ones among system operating procedures are processed into components, which are then combined to prepare operating procedure documents.

In accordance with the operating procedure documents so prepared, operators manipulate from a starting time until a deadline, both determined in advance for each. In this process, the operator to follow each operating procedure document and the starting time of manipulation are determined by the operation manager responsible for management of system operation (operation allocation). In operation allocation, the operation manager has to take into consideration the time taken to implement each operating procedure document, each operator's workload and the number of his or her experienced occasions (skill level). The operation manager, after fully grasping all these factors, is required to so plan allocation as to enable the smallest possible operating staff to implement the largest possible number of operation items. Especially in operating a system, since the system works after and as a result of manipulating the system and a waiting time arises until the end of the work, the operator is placed in a waiting situation.

Known techniques applicable to allocation of operating procedures to operators include one disclosed in Japanese Unexamined Patent Application Publication No. 2007-141039, according to which workloads are allocated to workers on a task-by-task basis. More specifically, by the disclosed method, workers' performance records are collected and tasks are so allocated as to maximize the overall efficiency (minimize the working hours) by prioritized allocation to operators with greater numbers of experienced occasions as judged from their past records. Further, Japanese Unexamined Patent Application Publication No. 2005-190392 discloses a method by which task allocation is so made as to uniformize operators' work experience levels, and Japanese Unexamined Patent Application Publication No. 2004-280171 discloses a method by which workers are so assigned as to minimize, in time of trouble, the time taken to address the trouble according to past records of troubleshooting.

Japanese Unexamined Patent Application Publication Nos. 2007-141039, 2005-190392, and 2004-280171 disclose techniques by which the working hours of the whole tasks to be allocated, but no method by which part of another task than the task initially allocated to an operator is allocated to him or her to be done during a waiting time. In this process of designing operation items of an information system including operating procedure documents, allocating operation items to operators and supporting presentation of manipulating procedures regarding operation items by operators, it is desirable to so allocate operation items as to enable them to efficiently implement manipulation. In particular, by predicting periods of manipulation by operators of operation items newly assigned to them and their waiting periods during system actions (system awaiting periods) from the records of implementing a plurality of system subjects by operators in manipulating procedure units and allocating tasks for operator manipulation even in system awaiting periods, more operation items can be implemented by a limited number of operators.

### SUMMARY OF THE INVENTION

An object of the present invention is to provide an operating plan formulation support system and method using an information processing device that supports allocation of operation items including a plurality of manipulating procedures to operators.

According to the present invention, information that determines whether a manipulating procedure is dominated by a period of manipulation by an operator (a case in which most of the working time is taken by manipulation of terminals or the like by an operator) or by a working period of a system (a case in which most of the working time is taken by processing by a computer without intervention by an operator) is stored, procedures already allocated to an operator are searched for a procedure in which the working time of the system is dominant, and some of the procedures of another operation item different from and implementable within the manipulating period of the first-mentioned procedure is allocated to the operator in parallel.

Further, the processing device is provided with a display unit, searches procedures already allocated to an operator for a procedure in which the working time of a system is dominant, and allocates to the operator in parallel some of the procedures of another operation item different from and implementable within the manipulating period of the first-mentioned procedure. When the already allocated manipulating procedure is presented to the operator on the display unit on the basis of the result of allocation, a switchover procedure and the partial procedure are presented after notifying the operator of the intended presentation of some of the procedures of the other operation item.

The invention makes it possible to allocate to an operator a part of a manipulating procedure of another operation item different from the procedure initially allocated to him or her even in a system awaiting period by placing the other operation item different from the procedure initially allocated to the operator in a system action awaiting state after he or she has manipulated one procedure, and thereby to enhance the operating efficiency (the number of implemented procedures per operator). As a result, the same number of operators can accept operation of a greater number of subjects.

### BRIEF DESCRIPTION OF THE DRAWINGS

FIG. 1 illustrates the overall configuration of an operating plan formulation support system;

FIG. 2 illustrates a typical configuration of an operation management server;

FIG. 3 charts the processing flow of manipulating procedure analysis;

FIG. 4 illustrates the configuration of an operator management DB;

FIG. 5 illustrates the configuration of an operation item management DB;

FIG. 6 illustrates the configuration of an operation history DB;

FIG. 7 illustrates the configuration of an operation history DB;

FIG. 8 illustrates an example of correlation analysis of the number of experienced occasions and manipulation time of an operator;

FIG. 9 illustrates the configuration of an operating procedure DB;

FIG. 10 charts the processing flow of allocation of operations;

FIG. 11 charts the processing flow of partial/multiple allocation;

FIG. 12 illustrates the configuration of an operation schedule DB;

FIG. 13 illustrates the configuration of a procedure switchover cost DB;

FIG. 14 illustrates one example of allocation of operations;

FIG. 15 illustrates an operation allocation screen on an operation manager's terminal;

FIG. 16 illustrates a manipulating procedure confirmation screen for operation items;

FIG. 17 illustrates a confirmation screen for results of operation allocation;

FIG. 18 charts the processing flow of manipulating procedure presentation;

FIG. 19A illustrates a manipulating procedure presentation screen and a screen to notify start of manipulation of another operation item; and

FIG. 19B illustrates a screen of presenting a procedure to an operator.

### DETAILED DESCRIPTION

### <Overall Configuration>

An exemplary embodiment of the present invention will be described in detail below. FIG. 1 shows an example of configuration of an operating plan formulation support system of this embodiment. This system includes an operation manager's terminal (120), an operator's terminal (121), an operation management server (100), which is an information processing device that executes processing in various ways, a storage (110) that stores various kinds of information needed for the execution of the processing, and a network (122) that connects the terminals, the server and the storage (FIG. 1). The storage (110) is a storage server used in common by the operation manager's terminal (120), the operator's terminal (121) and the operation management server (100). To add, the configuration of this system is not limited to what is shown in this drawing, and, for instance, it may as well be such that some processing is executed by another server connected via a network or that some database information is stored in another storage connected via a network. Alternatively, by having a data center centrally manage various ways of processing (101 to 108) by the operation management server (100) and the various databases (111 through 117) and connecting the operation manager's terminal (120) and the operator's terminal (121) to the data center via a network, a cloud service can be configured for remote utilization.

### <Processing by Whole System>

The system first supports an operation manager who manages the overall operation of the system to be managed and operators in charge in the preparation of manipulating procedures common to the whole system as operating procedure components, accomplished via the operation manager's terminal (120), preparation and management, including correction, of operating procedure documents combining operating procedure components, management of operation items, management of operation items, allocation of operation items to operators, confirmation of operation results, and management of operators. It also designates for each operator through the operator's terminal the operation item to be implemented by the operator, and further delivers an operating procedure document to the pertinent terminal. The operator's terminal (121) displays to the operator in charge of operation manipulating procedures in units of procedural step, and supports the operator in secure operational manipulation by making sure at each step whether or not the result of system manipulation is identical with the expected value.

For the above-described support to operational manipulation, the operation management server 100 executes processing in various ways.

(1) The operation manager prepares an operation checklist (operating procedure document) via the operation manager's terminal (120).

First, to prepare an operating procedure component, processing to prepare an operating procedure commonly implemented by a system, such as middleware, as an operating procedure component and to manage it is executed (101). The procedure is to express the flow of manipulation in a flow chart, and the manipulating procedure and a confirmed item are defined at each node of the flow. Next, in preparing and managing, such as correcting, the operating procedure document, processing to prepare the operating procedure document by using the operating procedure component and to manage it is executed (102). In the operating procedure document, similarly to the operating procedure component, the flow of manipulation is edited in a flow chart form, and by introducing an operating procedure component into each node of the flow chart, the operating procedure document is prepared. To add, elements determined at the time of using the operating procedure component (e.g. the system name, set particulars and so forth of the object) have to be designated as parameters at the time of introducing the component.

(2) The operation checklist prepared by the operation manager is allocated to the operator.

Next, in the management of operation items, the conditions of implementing already prepared operating procedure documents are managed as classified by the system subject to be managed (103). The conditions of implementation mean the starting time and deadline of the pertinent operation item. Further in the management of operation items, processing to deliver the operating procedure document to the operator's terminal (121) after allocation to an operator is determined is executed. Next, in allocating an operation item to the operator, processing (104) to analyze the manipulating procedure in preparation for implementing the manipulation to the operator, processing (105) to calculate the length of manipulating time on an operator-by-operator basis, and processing (106) to allocate manipulating procedures to operators following these two ways of processing are executed. In the manipulating procedure analysis processing (104), it is determined by analyzing the past operation history whether the time of manipulation by the operator is dominant (most of the working time is spent by the operator's manipulation of terminals or the like) or the time of awaiting system action is dominant (most of the working time is spent by processing by the computer without intervention by the operator). In the processing (105) to calculate the length of manipulating time, the time required for each manipulating procedure is estimated for each individual operator according to the experience level of the operator regarding the object manipulating procedure and the trend of time spent on manipulation in the past.

(3) The operator implements contents of the allocated operation checklist.

Next, regarding confirmation of the result of operation, processing is executed to enable all the implemented contents of the operation history to be searched for and displayed by recording the operator implementing each manipulating procedure and his or her manipulating time (107). Into the operation history, the time taken by each manipulating procedure is recorded by requiring, when presenting the manipulating procedure to the pertinent operator at the operator's terminal (121) logged into by using the ID of the operator, the operator to make a manipulation to confirm. Next in operator management, management of operator registration, performance management including shift allocation and referencing each operator's past operation records are processed (108). Also, the manipulating procedure allocated by operation allocation processing (106) is presented (109) on the operator's terminal (121).

Further, data used in each of the various ways of processing on the operation management server (100) is stored on the storage (110) as databases (DBs). The DBs include an operating procedure component DB (111) that holds such information as procedures of operating procedure components, confirmation items and parameter elements, an operation item management DB (112) that holds such information as time conditions of operation items, an operation schedule DB (113) that holds starting times of operation items and information on allocation to operators in charge, an operating procedure DB (114) that holds configurative information on operating procedure documents with respect to operation items, an operator DB (115) that holds information on operators responsible for manipulation of operating procedures, an operation history DB (116) that holds past starting times in units of operating procedure, information on operators in charge and the like, and a procedure switchover cost DB (117) that holds time information needed when implementation is switched over to the manipulating procedure of another operation item. Details on each DB will be described in later paragraphs.

### <Typical Configuration of Server>

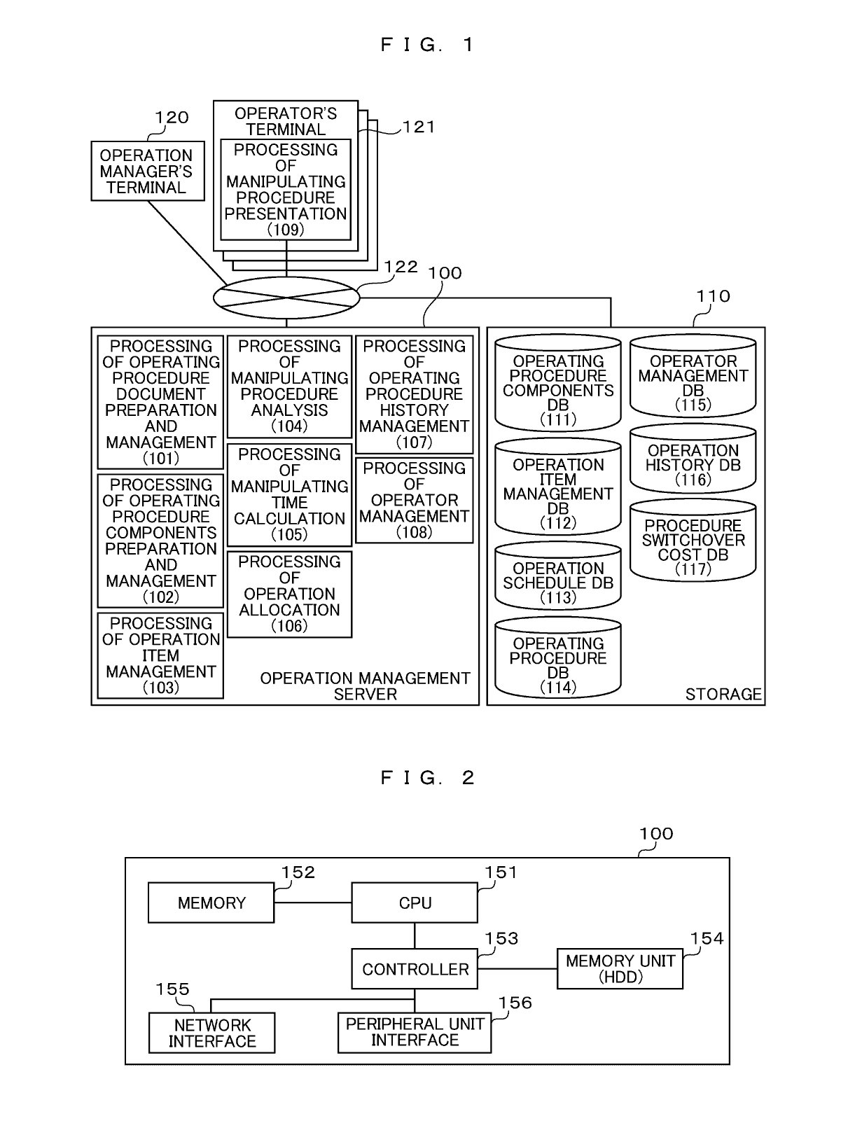

FIG. 2 shows a typical configuration of the operation management server. The server includes a central processing unit (CPU) 151 that executes arithmetic processing, a memory 152 that temporarily stores program data, a controller 153 that controls various interfaces, a memory unit 154 that holds various data and programs, a network interface for connection to external networks, and a peripheral unit interface for connection to peripheral units including a display and a keyboard. Programs for executing various ways of processing shown in FIG. 1 (101 through 108) are stored in the memory 152, and are executed by the central processing unit (CPU) 151.

### <Manipulating Procedure Analysis>

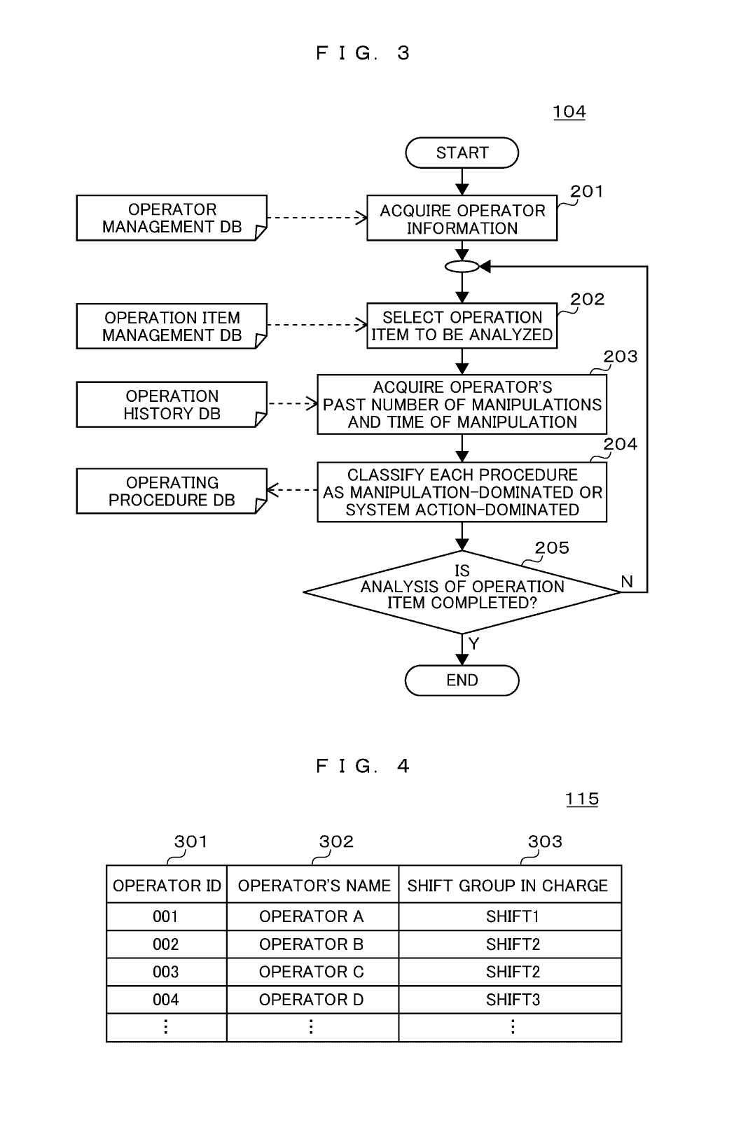

In the following paragraphs, first the processing of manipulating procedure analysis (104) will be described in detail. FIG. 3 charts the processing flow of manipulating procedure analysis (104). The processing of manipulating procedure analysis analyzes the past operator-by-operator operation history, and determines whether the time of manipulation by the operator is dominant or the time of system action is dominant. The time of manipulation by the operator means the time taken to manipulate the screen or devices with a keyboard, mouse or the like during the pertinent procedure. The time of system action is the time taken until the system responds to any manipulation by the operator or the time taken until a system action is completed.

First, a list of names of operators under management by the system is acquired from the operator management DB (115) (201). FIG. 4 shows an exemplary configuration of the operator management DB (115). In this example, information on the operator ID (301), operator's name (302) and shift group in charge (303) is defined. The shift group refers to a length of time during which a given operator is in charge of operation; for instance, if one shift means eight hours on duty, the shift group is allocated to operators on the basis of three shifts per day including shifts that come on a holiday.

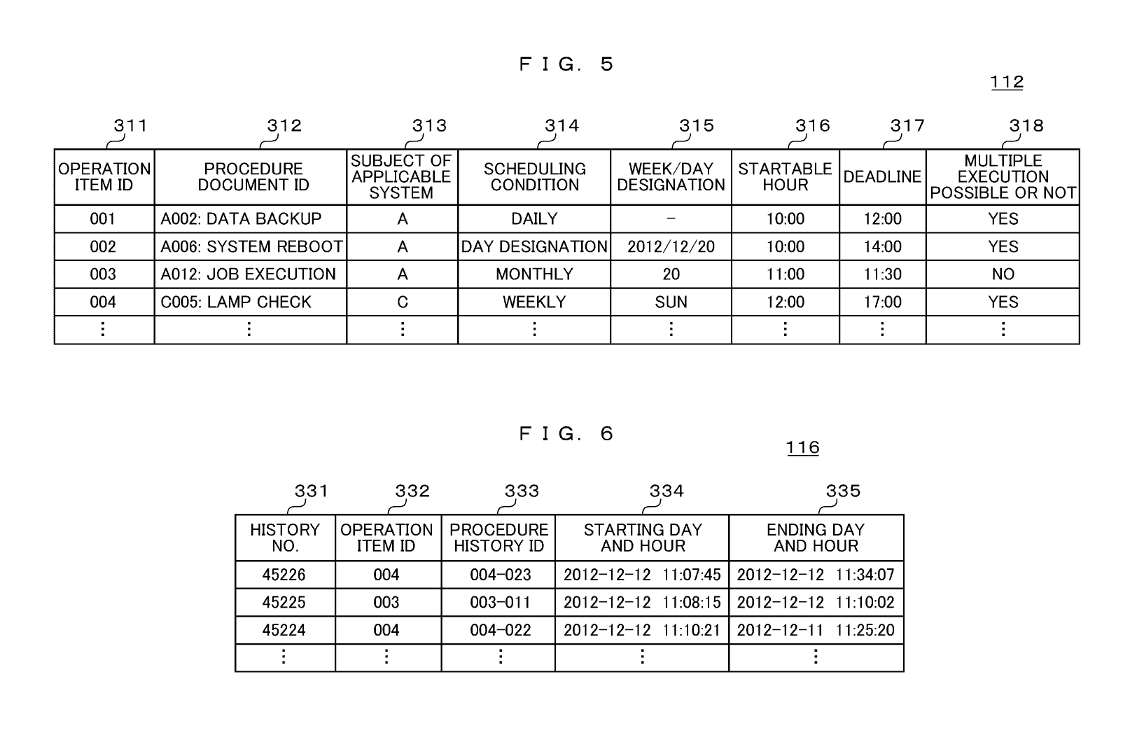

After the operator information is acquired, then the operation item management DB (112) is referenced, and an operation item to be analyzed is selected (202). FIG. 5 shows an exemplary configuration of the operation item management DB (112). In this example, information on the ID (311) of each operation item, the ID (312) of the operating procedure document matching the pertinent operation item, the subject (313) of applicable system, scheduling condition (314), week/day designation (315), startable hours (316), deadline (317) and possibility (318) of multiple execution is defined.

The systems calls up a manipulating procedure by referencing the operating procedure DB (114) in which the manipulating procedure of the operation item out of the operating procedure document ID (312). The subject of applicable system (313) indicates the class of the subject system to be operated. Subject systems are usually classified by customer. The scheduling condition (314) represents the scheduling condition for implementation of the pertinent operation item, which is implemented under the week/day designation (315). For instance, the operation item is implemented in fixed hours if it is daily, on a fixed day of the month if it is monthly, or on a specific day if that day is designated. The startable hours (316) is the time, designated in hours of the day, when the pertinent operation item can be started, and the deadline (317), similarly designated, is the time by which the final manipulating procedure of the operation item is to be completed. The multiple execution possible or not (318) means whether or not, when operation items are allocated to operators as will be described in a subsequent paragraph, if an operator is to manipulate some system and the system is in action causing the operator to wait, allocation of another operation item can be allocated to the same operator in parallel.

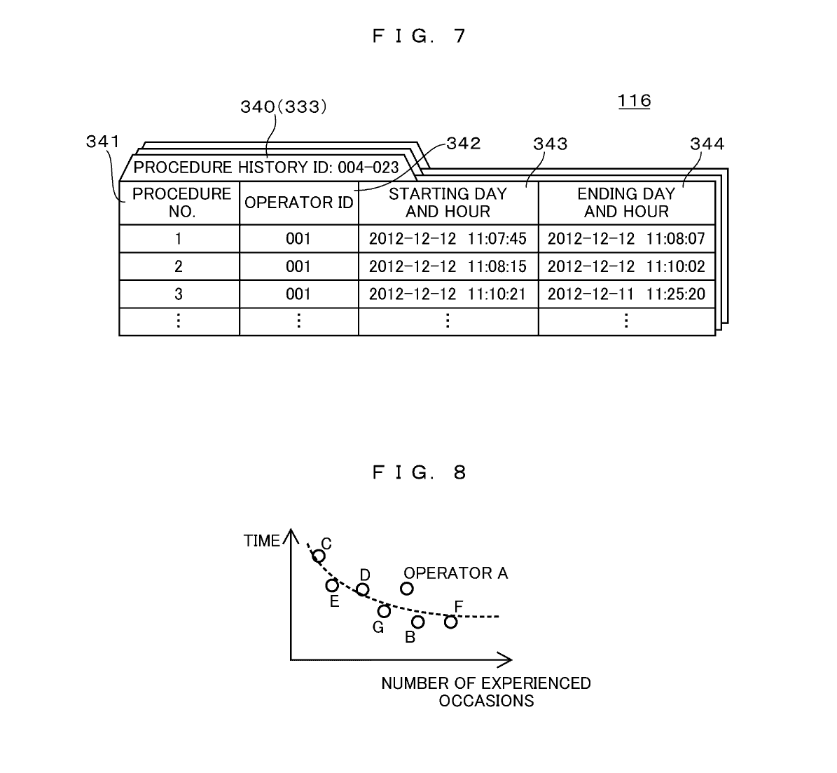

Next, the operation history DB (116) is accessed to extract all the number of manipulations and the times of manipulation of the operation items to be analyzed, classified by operator (203). Examples of operation history DB (116) are shown in FIG. 6 and FIG. 7. As shown in FIG. 6, history numbers (331) are assigned in the order of operational manipulation, and a procedure history ID (323) for referencing the DB for recording the name of the operator having manipulated, the starting day and hours and ending day and hours of each procedure are recorded with respect to the implemented operation items ID (332). Also, the starting day and hours (334) and ending day and hours (335) are recorded in unit of operation item. In FIG. 7 showing data of one-line equivalent of FIG. 6, the operator ID (342), starting day and hours (343) and ending day and hours (344) of implementing the manipulating procedure matching the procedure history ID (340) are recorded. From these items of information, calculation of the operator-by-operator number of manipulations of each procedure and extraction of manipulating time can be done (203).

By utilizing the results of these calculation and extraction, each procedure is classified according to whether it is manipulation-dominant or system action-dominant. Conceivable methods of this classification include one by which the correlation between the number of manipulations (number of experienced occasions) implemented and the manipulating time taken by the operator is calculated. For instance, FIG. 8 is a drawing in which the operator's number of experienced occasions and manipulating time are plotted in a planar graph form. If the operator's manipulating time is dominant in a procedure, the operator's manipulating time will conceivably decrease with an increase in his or her number of manipulations (number of experienced occasions). Or if the system acting time is dominant in the procedure, a conceivable tendency is that the manipulating time is constant irrespective of the operator's number of manipulations or that the number of manipulations increases at a constant rate with the lapse of time of implementing the operation.

This processing is applied to every procedure for each operation item to classify it between what is dominated by the operator's manipulating time and what is dominated by the system action time, and the result is outputted to the operating procedure DB (114).

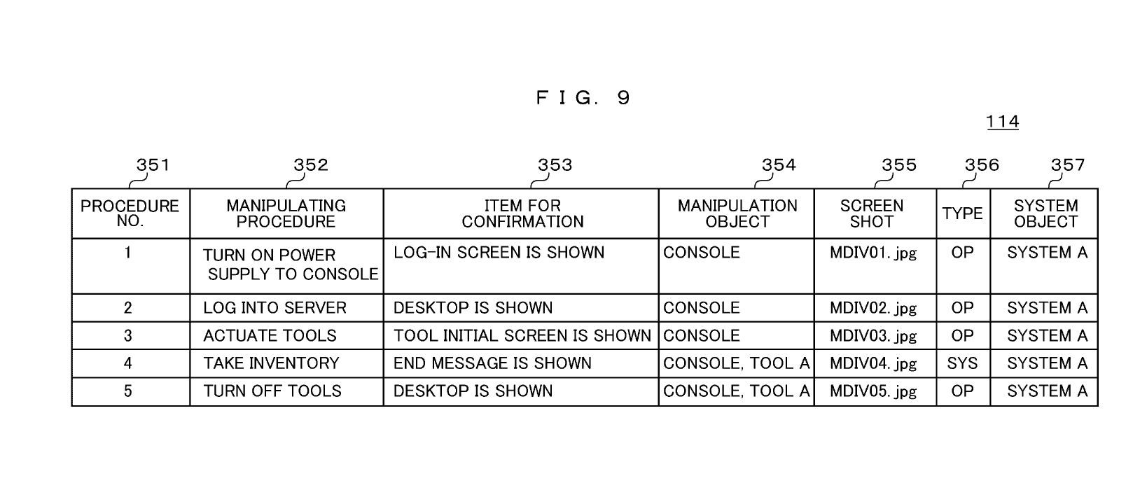

An example of operating procedure DB (114) is shown in FIG. 9. The operating procedure DB includes procedure numbers (351), manipulating procedures (352), items (353) for confirmation, manipulation objects (354), screen shots (355), types (356) and system objects (357). The type (356) is the identifier that is to be written into the result of execution of the processing of manipulating procedure analysis (104) and indicates whether a given procedure is dominated by the operator's manipulating time (OP) or is dominated by the system action time (SYS). The manipulating procedure (352) defines specifics of the manipulation done by the operator, and the item (353) for confirmation defines particulars of the result expected to follow the manipulation. The manipulation object (354) defines the object to be manipulated when the manipulating procedure (352) is implemented. The manipulation objects include such devices as a console, remote desktop, applications, tools and server. The screen shot (355) designates to the operator an image on the manipulation screen (screen shot) or the file name of an image of the device to be manipulated. The screen shot is intended to assist the operator in understanding explanation of manipulating procedures and items for confirmation and thereby to support him or her in reliable execution and confirmation of procedures. The system object (357) defines the identification IDs of systems and devices to be manipulated.

### <Processing of Operation Allocation>

Now, the processing of operation allocation (106) to determine the implementation time of operation items and their allocation to operators (hereinafter referred to as “operation allocation”) will be described. FIG. 10 charts the processing flow of operation allocation. In this embodiment, operation allocation is supposed to be done on a shift-by-shift basis. First, operation items satisfying the time condition of the shift to which the operation allocation is to be done are extracted from the operation item management DB (112) (401). Satisfying the time condition means that the startable hours (316) of the operation item management DB (112) for each operation item is within the period of the pertinent shift. In other words, operation items which can be started within the shift period are extracted. Next, the operator management DB (115) is read in, and the ID of the operator responsible for the pertinent shift is extracted (402).

Next, out of the operation items acquired at step 401 to which no operator has been allocated yet, the operation item earliest in startable time (316) is selected (403). Next, the processing (105) of manipulating time calculation is called up, and the time taken if the operation items are allocated to eligible operators until the completion of all the manipulations for the operation items is calculated (predicted). In this processing, the number of experienced occasions of each operator regarding procedures in the operation item is calculated by reading in the operation history DB (116), and a manipulating time taking account of the number of experienced occasions is predicted for manipulating procedures for which the type (356) in the operating procedure DB (114) is classified as “dominated by the operator's manipulating time (OP)”. For manipulating procedures classified as “dominated by the system action time (SYS)”, the manipulating time is predicted from the time trend for the same procedure in the same system according to the operating procedure DB (114).

Next, the operation schedule DB (113) that manages the allocation state of operation items is read in and searched for any operation items already allocated to all the operators (405) in the period from the startable time for the operation items until the completion of the operation items predicted on an operator-by-operator basis. If there are no allocated operation items, “usual allocation” (406) by which all the operation items to operators to whom no allocation has been made is implemented. If other operation items have been allocated to all the operators in the period from the startable time for the operation items until the completion of the operation items predicted on an operator-by-operator basis, “partial allocation” by which some of allocatable operation items are split and allocated for the non-allocated period, or “multiple allocation” (407) by which allocation is overlapped for already allocated operation items in parallel for a waiting time in connection with system action is implemented. In the following description, these two ways of allocation are collectively referred to as “partial/multiple allocation”.

In “usual allocation”, a whole operation item is allocated to an operator to whom no operation item has been allocated. If there are more than one such candidate operator for allocation, allocation will be made so as to optimize the objective function in the allocation. If the objective function is set to be “minimization of working time”, allocation will be made to the operator whose time of completing the operation item is the earliest. Or if the objective function is set to be “uniformization of experienced occasions of the operator regarding the operation item”, allocation will be made to the operator least experienced in the operation item within a range of being able to meet the deadline (317). In “partial/multiple allocation”, some part of the operation item is split and allocated into an unengaged period of an operator, or allocation is made to overlap an already allocated operation item in parallel. The processing flow will be described in detail in subsequent paragraphs.

If, after the end of usual allocation (406) or partial/multiple allocation (407), allocation of allocatable operation items to operators in the shift is not completed, namely in the presence of remaining allocatable operation items, processing is repeated from step 403 until allocation of all the operation items is completed (408). Or if the allocation of all the operation items is completed, then the completion time of the allocated operation items is extracted, and whether or not each operation item has met the deadline (317) is checked (409). If there is any operation item failing to be completed by the deadline, the operation manager shall be notified of impossibility to allocate under the given conditions (the numbers of operators and of operation items and deadline) (411). The operation manager will permit failure to meet the deadline, increase the number of operators or alter the conditions of allocation, and attempt allocation again. To add, conceivable alterations of the conditions of allocation include, for instance, permission of partial/multiple allocation and controlling the objective function (giving priority to minimizing the period of implementation over uniformization of experienced occasions). If all the operation items have been found meeting the deadline, the allocation will be finalized and, by reading the operation schedule DB in, operating procedures for the operation items will be delivered to operator's terminals from which the operators having received allocation have logged in by the manipulation start time of each operation item (410).

### <Partial/Multiple Allocation>

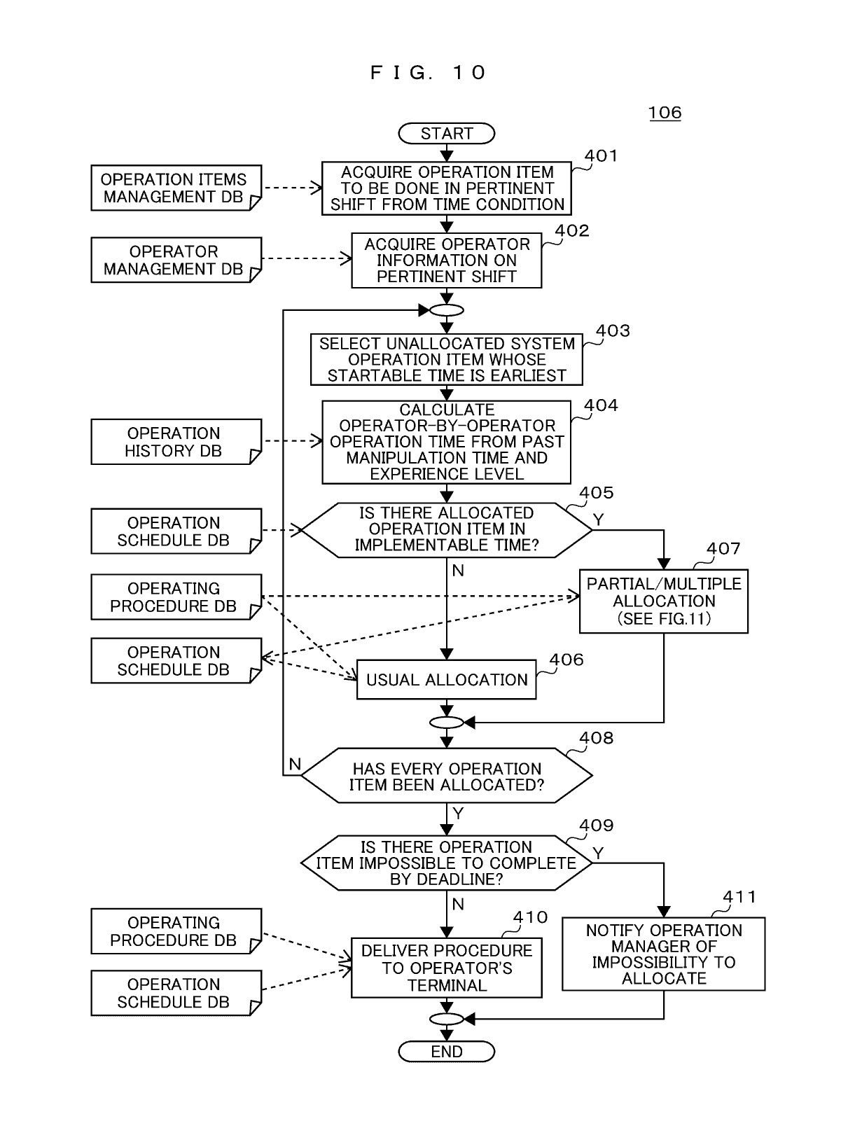

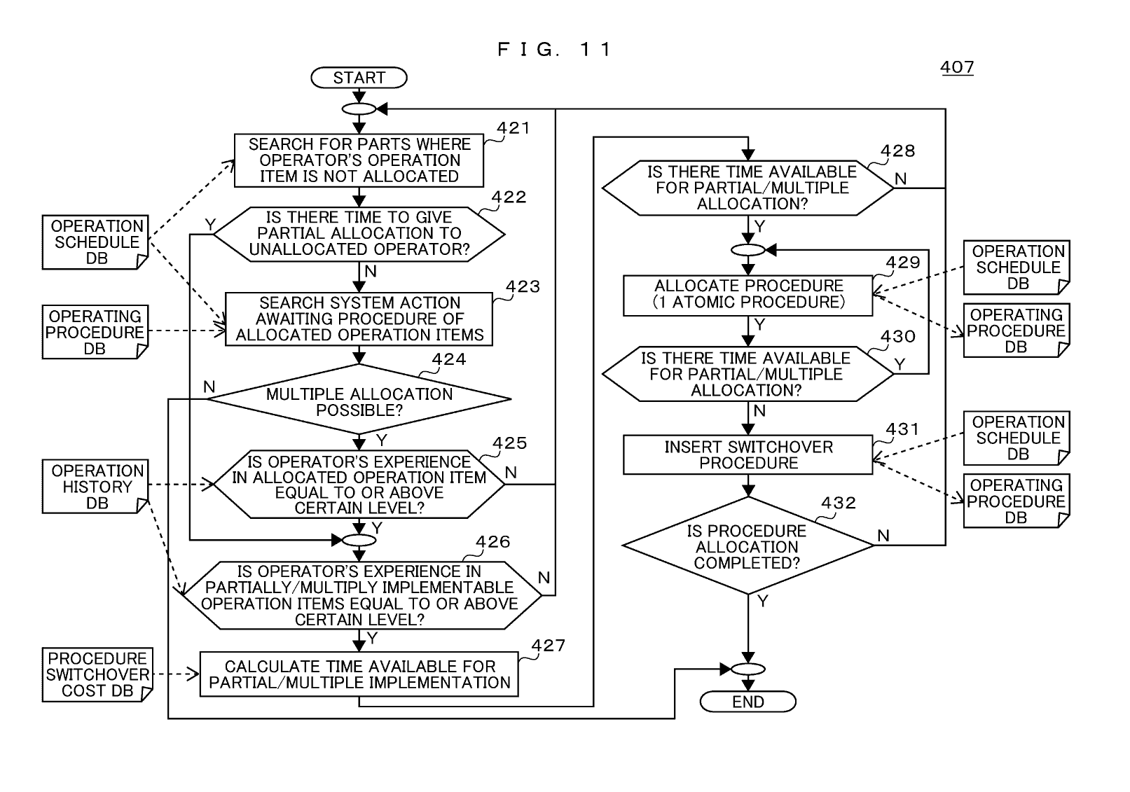

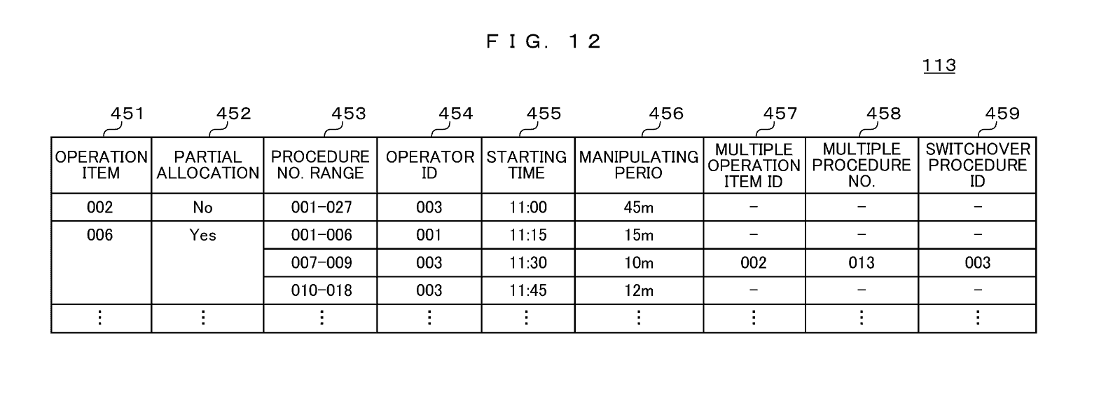

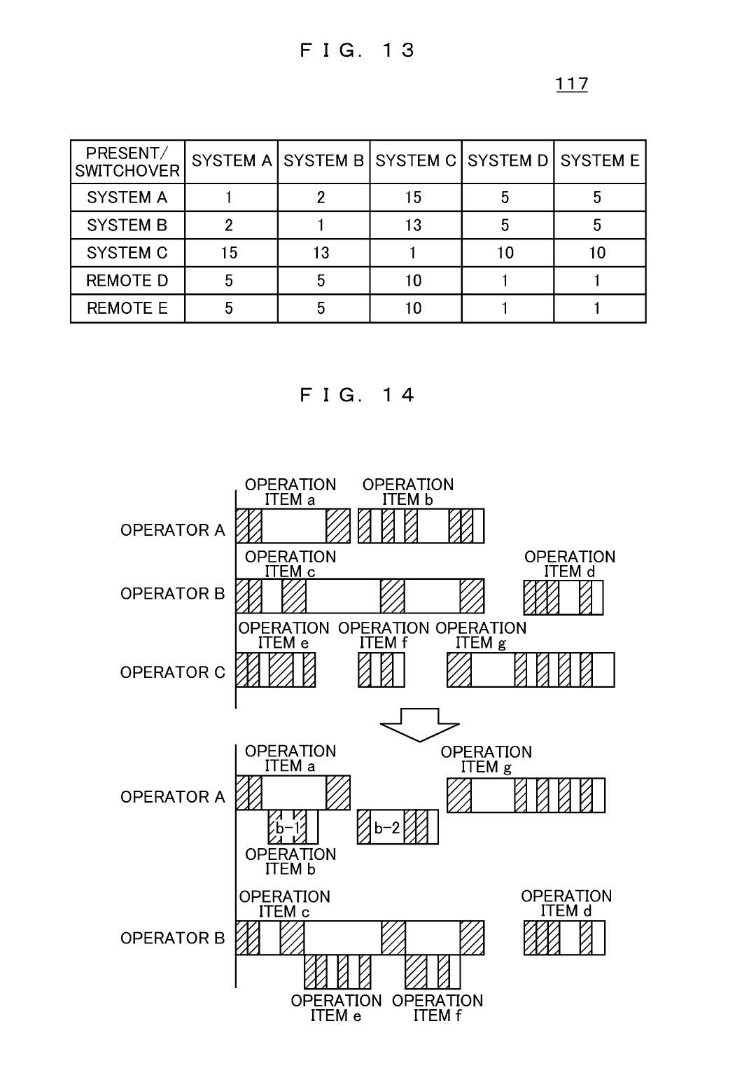

Now, the processing flow of partial/multiple allocation (407) charted in FIG. 10 will be described. At step 405 of the operation allocation processing charted in FIG. 10, if, during the period from the startable time of given operation items until the time of their completion predicted on an operator-by-operation basis, other operation items have already been allocated to all the operators, the processing flow of partial/multiple allocation (407) shown in FIG. 11 is executed. The partial/multiple allocation means that some manipulating procedures of operation items are partially allocated into an unengaged period of an operator or, to operators to whom operation items are already allocated, manipulating procedures of allocation objects are partially and multiply allocated in parallel to procedures for which a waiting time has arisen in connection with system actions.

First, by reading the operation schedule DB (113) in, any part that is within the startable hours for the operation items to be allocated and no operator's operation item is as yet allocated is searched for (421). This means an attempt to allocate, when there is no operator to whom any allocation has been made but who can implement the whole operation item though there is an operator who can implement a part of the operation item to be allocated at step 405, the manipulating procedure for the pertinent part to the latter operator. In other words, in allocating the part of the operation item to be allocated, it is determined whether or not there is an unengaged time for an operator having a time not less than a predetermined length (422). If there is such an unengaged time, the allocation is considered possible and then, by referencing the operation history DB (116) for the operation item to be split and partially allocated, it is determined whether or not the experience (the number of past experienced occasions) of the operator to whom the allocation is to be made is not less than a certain level (426). To add, this is intended to reduce the risk of manipulation errors by requiring experience of not below a certain level if the operation item is to be implemented in the split way, which would involve addition of such elements as interruption and restart of the procedure to the operating procedure. The required experience level is designated by the operation manager in advance.

Or in the absence of any time to which the part of the allocatable operation item can be allocated (422), then the operation schedule DB (113) and the operating procedure DB (114) are referenced, and the manipulating procedures of already allocated operation items are searched for any procedure awaiting system action in the order of startable time earliness (316) for each operator within the limitation of the deadline (317) for the pertinent operation item (423). A procedure awaiting system action can be searched for by referencing the type (356) in the operating procedure DB (114) regarding already allocated operation items. If there is any procedure awaiting system action, the partial/multiple allocation possible flag (318) of the operation item management DB is “Yes” and the manipulation time for the procedure awaiting system action is not shorter than a predetermined length, multiple allocation is determined to be possible (424). If impossibility of multiple allocation is determined, step 407 is ended. If multiple allocation is determined to be possible, next the operation history DB (116) is referenced to determine whether the operator's experience with the allocated operation item is not below a certain level (425). This is intended to reduce the risk of manipulation errors by requiring experience of not below the required level even with the allocated operation item because execution is to be switched over to a part of a procedure in another operation item. If the operator's experience is found to be not below the required level, candidate operators for operation items to be multiply allocated are also determined as to whether their experiences are not below the required level (426).

If the experience level is found to be below the predetermined level at a conditional branch 425 or a conditional branch 426, another operator is selected for allocation and processing is repeated from step 421. If his or her experience is not below a certain level, the procedure switchover cost DB (117) is referenced to calculate the time during which the operation item to be allocated next can be partially or multiply implemented (427). If then a multiple manipulation is to be done, the operator will have to do switchover manipulations to shift to a system having a different object or a screen on the terminal when implementing the manipulating procedure of another operation item in parallel to the procedure awaiting system action. Also in a partially allocated manipulating procedure, interruption and restart of the procedure is required, necessitating shifting and switchover manipulations as in the foregoing case. The time taken by these shifting and manipulations as the procedure switchover cost, the time in which the manipulating procedure defined by the operation item when multiple or partial allocation is implemented is the predicted period of the procedure determined by the manipulating procedure in the allocated operation item to be in a system action state or the balance of subtracting the procedure switchover cost equivalent from the period of the unallocated part of the operation item for the candidate operator for allocation. It is determined whether allocation of one manipulating procedure from the head of the operation item to be allocated is possible from this balance of subtraction of the procedure switchover cost equivalent, namely whether it is longer than the manipulation period of the pertinent manipulating procedure (428).

To add, for the manipulating procedure to be partially/multiply allocated with the procedure switchover cost taken into consideration, allocation in unit not smaller than a certain number is likely to be more efficient. For this reason, the determination may as well be based on whether or not the time length after subtraction of the procedure switchover cost equivalent is not smaller than a certain number of manipulating procedures. If it is determined that there is no allocatable time, the processing from step 421 onward is repeated for another operator as the candidate for allocation. If allocation is determined to be possible, allocation is made for one manipulating procedure (429), and the allocation of one manipulating procedure is repeated (430). When the allocable time has run out, no more partial/multiple allocation is possible, and accordingly a switchover procedure needed for execution of the foregoing allocation procedure is inserted (431). The switchover procedure means a procedure regarding shifting from one system to another or terminal switchover manipulation, matching the procedure switchover cost described in the foregoing paragraph. It includes a switchover procedure to a manipulating procedure for multiple allocation and a manipulating procedure for return to the system action awaiting procedure after implementing the pertinent manipulating procedure.

After completing insertion of the switchover procedure, if allocation of all the manipulating procedures of the operation item to be allocated is completed, the result of allocation is written into the operation schedule DB (113) to complete the processing of multiple (partial) allocation (432). If there is any unallocated manipulating procedure, the processing is repeated from step 421 onward.

To add, although the foregoing description of the processing of operation allocation presupposes its prior execution as planned for the implementation of the operation item, it is also possible to make reallocation by processing operation allocation on an ad hoc basis if, for instance, the manipulation of an operation item is found taking a significantly longer time than predicted or operator manning planned in advance has been altered to address the occurrence of a trouble or some other contingency.

### <Operation Schedule DB>

FIG. 12 shows an example of configuration of the operation schedule DB (113) into which the result of implementation of operation allocation is to be written. The operation schedule DB includes operation item IDs (451) for distinguishing allocated operation items, partial allocation flags (452) indicating whether or not the pertinent operation items are split, procedure number ranges (453) indicating, if split allocation, the unit of the allocation, the IDs (454) of the operators who implement the respectively pertinent manipulating procedures, starting times (455) of manipulating procedures in units of allocation, periods (456) of time taken to implement the manipulating procedures in unit of allocation, the operation item ID (457) of the multiple allocation destination and the manipulating procedure number (458) of the allocation destination when the manipulating procedure in units of allocation is to be multiply allocated in parallel to another procedure, and the ID (459) indicating the switchover procedure at the time of multiple allocation.

### <Procedure Switchover Cost>

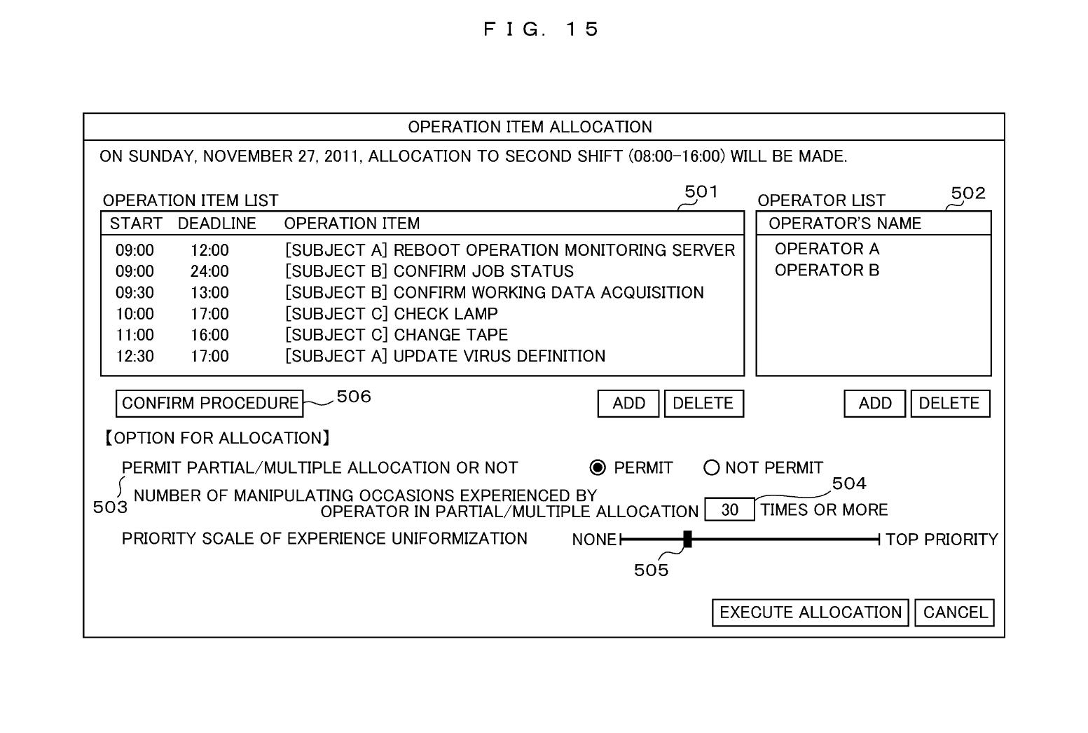

Next, FIG. 13 shows an example of configuration of procedure switchover cost DB (117) that defines the length of time taken in procedure switchover at the time of partial/multiple allocation. In the table of FIG. 13, the left column lists the current objects of manipulation, and the top row, the objects of manipulation after switchover. Although a case of symmetry is shown in FIG. 13 regarding the lengths of time taken to switch over, there can also be a case of asymmetry. In the case shown in FIG. 13, for instance, a changeover from system B to system A takes an equal length of time to a change over vice versa.

As described in the foregoing paragraph, execution of a manipulating procedure for the other system in implementing multiple allocation requires shifting from one system to another or terminal switchover manipulation, and therefore the length of time required to take these actions is defined. To add, the systems to be manipulated are defined in the system objects (357) of the operating procedure DB (114); the system objects (357) are identified for the currently executed manipulating procedure and each of the manipulating procedures to be multiply executed, and the cost is figured out by referencing the procedure switchover cost DB (117).

### <Example of Allocation Result>

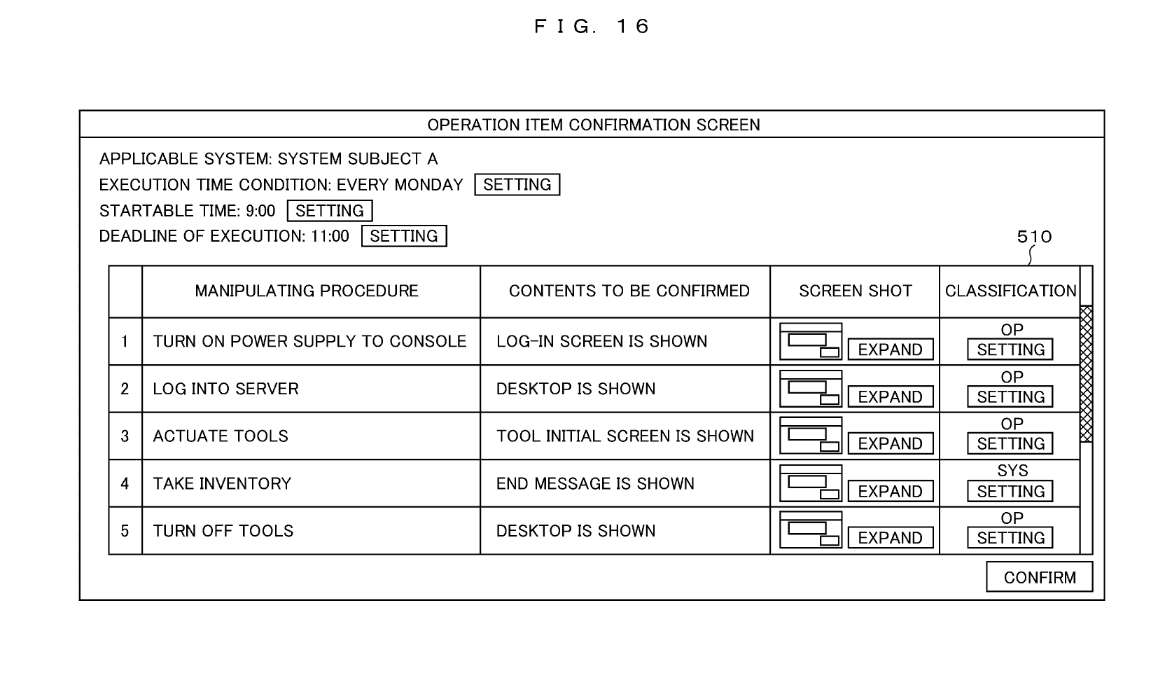

One example of allocation of operation items to operators made by the technique so far described is shown in FIG. 14. The upper part of FIG. 14 illustrates the result of usual allocation implemented units of operation item, which is a conventional technique, and the lower part of FIG. 14, the result of application of partial/multiple allocation according to this embodiment. Bold line quadrilaterals represent operation items, and thin line quadrilaterals within bold ones, manipulating procedures. Thin line quadrilaterals daubed with oblique lines represent manipulating procedures determined to be dominated by operator's manipulating time, and blank ones, manipulating procedures determined to be dominated by system action time. It is seen from the lower part of FIG. 14 that, by allocating to a procedure dominated by system action time, namely a procedure awaiting system action, a part of a procedure of another operation item, the number of operators can be reduced from three to two and the manipulation is still possible.

### <Screen of Operation Manager's Terminal in Operation Allocation>

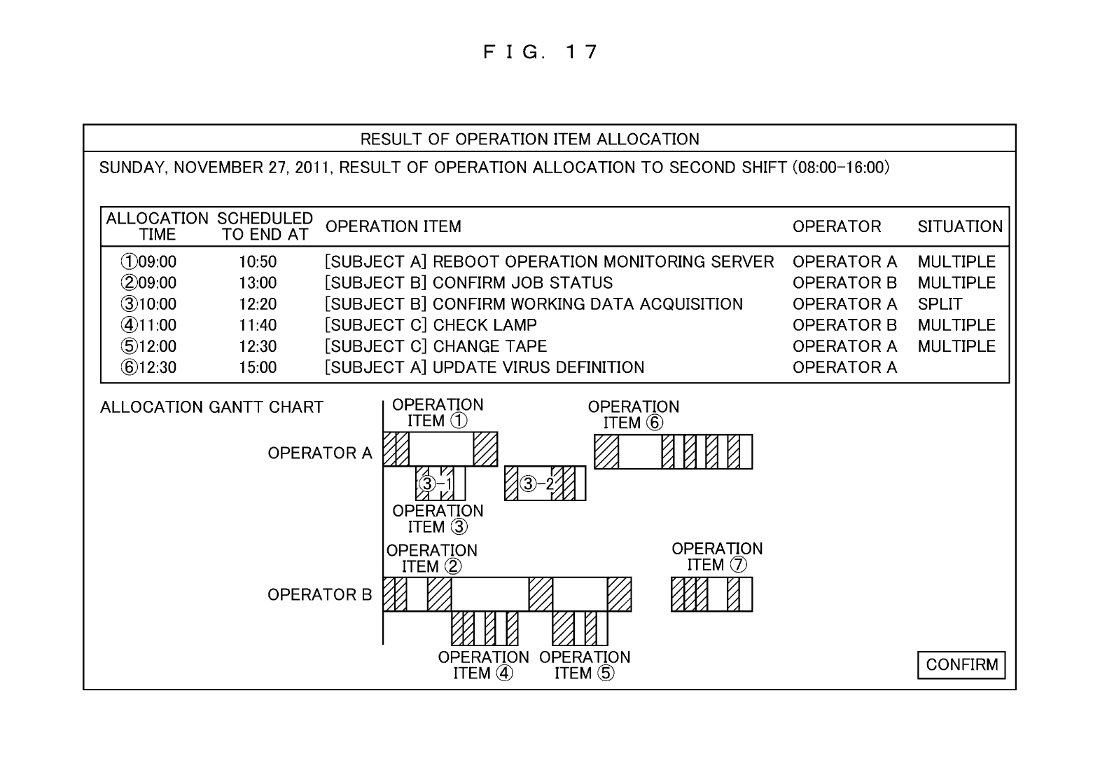

Next, terminal manipulation by the operation manager when using the processing (106) of operation allocation will be described. FIG. 15 shows an example of display on the operation manager's terminal in operation allocation. In allocating operation, the operation manager has to designate operation items to be allocated and their operators. Whereas operation items are basically extracted according to the time condition coinciding with the object shift of the operation item management DB (112), it is also possible to individually add or delete operation items (501). Further, details of manipulating procedures of each operation item can be confirmed (506). Similarly, regarding operators as well, they are basically extracted from the shift group in charge (303) defined in the operator management DB (115), but operators can also be added or deleted as the situation requires (502).

In allocating operations, an option for allocation can be set. The option for allocation permits designation of whether or not to opt for the partial/multiple allocation, described in the foregoing description (503). Further, at the time of permitting partial/multiple allocation, the number of experienced occasions can be so designated that operators with a number of experienced occasions not below a certain level can receive partial/multiple allocation (504). Also, it is possible to designate to what extent uniformization of the number of experienced occasions of operation should be given priority (505).

### <Manipulating Procedure Confirmation Screen for Operation Items>

When an operation item is selected out of an operation item list (501) in FIG. 15 and a confirm button (506) for manipulating procedure is pressed down, an operation item confirmation screen shown in FIG. 16 is displayed. On this screen, details of each manipulating procedure managed under the operating procedure DB (114) are displayed in addition to the execution time condition, startable time and deadline of execution managed under the operation item management DB (112). For each procedure, classification as to whether a given procedure is dominated by the operator's manipulating time (OP) or is dominated by the system action time (SYS), as analyzed in the processing of manipulating procedure analysis (104), is displayed (510). The operation manager can also individually set this classification on the screen.

### <Confirmation Screen for Result of Operation Allocation>

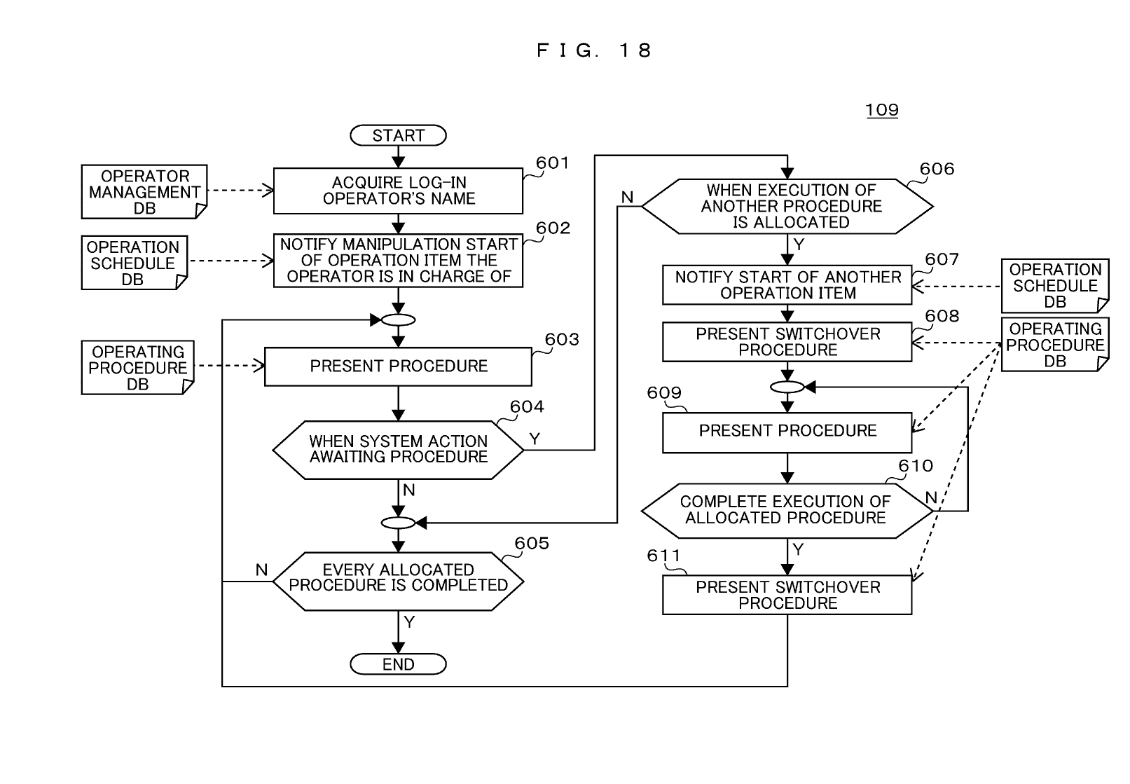

After completion of the processing of operation allocation (106), the situation of allocation of each operation item to operators and the implementation timing of the operation item are displayed for the operation manager. An example of screen showing the result of operation item allocation is shown in FIG. 17. On this screen, the allocation time, ending schedule, operator in charge and whether or not multiple/partial implementation to will be done regarding each operation item are displayed. The multiple implementation means that the operation item includes a part to be implemented in parallel to another operation item, and partial implementation means that the operation item will be implemented in a split way. In the lower part of the screen, a Gantt chart (bar graph showing the progress of work among others) showing the situation of allocation is displayed.

### <Presentation of Manipulating Procedure to Operator's Terminal>

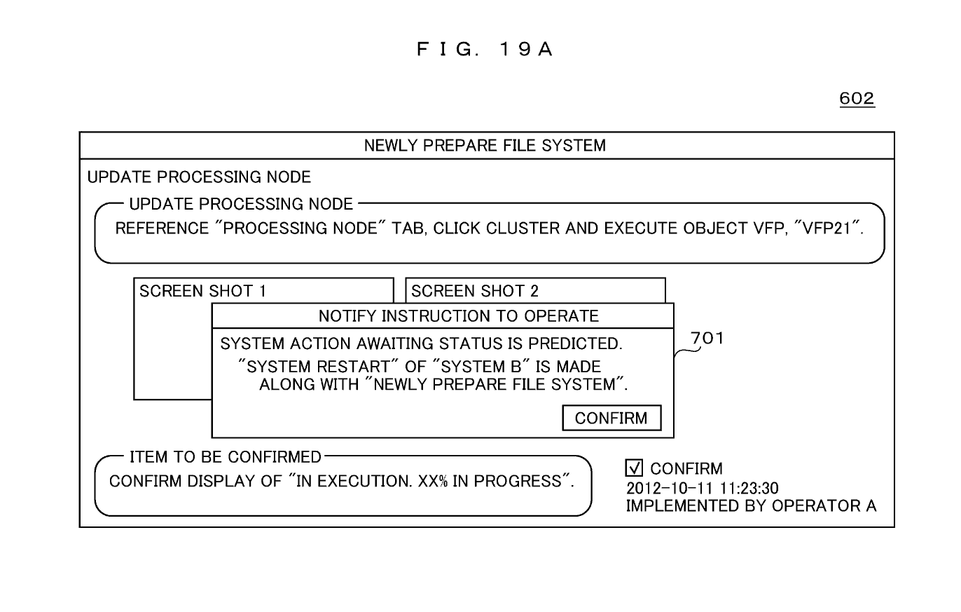

Next, the processing of presenting on the operator's terminals to operators (109) of the manipulating procedures of the operation items allocated by the processing of operation allocation (106) will be described. FIG. 18 charts the processing flow of presenting an allocated manipulating procedure to an operator on the operator's terminal. The operator logs into the operator's terminal by using his or her ID and receives indication of the operation item he or she is to take charge of and presentation of the manipulating procedure. First, the system references the operator management DB (115) and acquires from the logged-in ID the operator's name (601). Then, the system references the operation schedule DB (113) and acquires the operation item the operator is to take charge of and its starting time. When the manipulation starting time of the operation item approaches, the system notifies the operator of the fact (602). The operator's terminal references the operating procedure DB (114), and presents a manipulating procedure on the screen of the operator's terminal (603). To add, various necessary items of DB information can be made available even in an off-line state for operation and presentation by downloading them from the storage (101) in advance in an appropriate way for the network connection environment. If the terminal is in an on-line environment all the time, the storage (101) can be referenced every time information is required.

Then, it is determined whether or not the presented procedure is the system action awaiting procedure (604). If it is not the system action awaiting procedure, it is determined whether or not the allocated procedure is completed (605) and if not, the next procedure presentation is repeated in the order defined in the operating procedure DB (114) (603). If the presented procedure is the system action awaiting procedure, the operation schedule DB (113) is referenced to determine if the manipulating procedure of any other operation item is multiply allocated (606). If the manipulating procedure of no other operation item is multiply allocated, the process advances to a conditional branch 605. Or if any other manipulating procedure is multiply allocated, first the operator is notified of the start of the manipulating procedure of the other operation item (607). Next, a switchover procedure for interrupting the ongoing manipulating procedure and implementing a new manipulating procedure is presented (608). After presenting the switchover procedure, the previously allocated multiple manipulating procedure is presented (609), and the presentation of a manipulating procedure is repeated until the end of execution of every previously allocated procedure (610) in an order defined in the operating procedure DB (114) (609). When the execution of every multiply allocated manipulating procedure is completed (610), a switchover procedure for resuming the manipulation of the interrupted system action awaiting procedure is presented (611), and the interrupted manipulating procedure presentation is resumed (603).

### <Procedure Presentation Screen for Operator on Operator's Terminal>

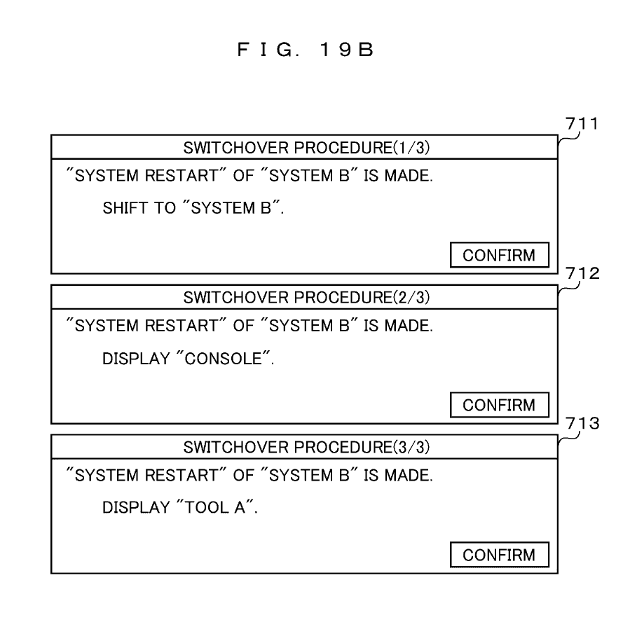

A procedure presentation screen for the operator on the operator's terminal and an example of screen to notify the operator of the start of execution of the manipulating procedure of another operation item (602) if any manipulating procedure is multiply allocated is shown in FIG. 19A. In the procedure presenting screen for the operator, as shown in FIG. 19B, particulars defined in the operating procedure DB (114) (manipulating procedures, items to be confirmed and screen shots) are presented for each manipulating procedure. Following the presented particulars, the operator implements manipulation of the system to be operated, confirms that the system action or state resulting from the manipulation is identical with the item to be confirmed, and implements a “Confirm” manipulation on the screen. When the confirm manipulation is implemented, the time of confirmation and the operator's name are recorded, and shifting to the next manipulating procedure (for instance, flip-flop manipulation on the terminal or pressing a button to the next step) is made possible.

By utilizing the screen interface of the operator's terminal, a manipulating time in manipulating procedure units and the history of the operator in charge can be acquired. Acquired histories are consecutively stored into the operation history DB (116).

If in the manipulating procedure presentation the manipulating procedure of any other operation item is multiply allocated besides the pertinent manipulating procedure, a notification of the fact is given on the screen (701). Upon confirmation of the notification by the operator, the switchover procedure is presented (608). An example of switchover procedure is shown in FIG. 19B. In this example, by using information on the system object (357) and the manipulation object (354) in the operating procedure DB (114), the switchover procedure (711 to 713) is presented to the operator.

What is claimed is:

1. An operating plan formulation support system using an information processing device that supports allocation of operation items each including a plurality of manipulating procedures to operators,
wherein the information processing device has:
a section that stores information that distinguishes whether a manipulating procedure is a first case in which a period of manipulation by an operator makes up a dominant part of a working period or a second case in which a period of system actions makes up a dominant part of the working period, and
a section that implements allocation of the operation items to operators by utilizing the distinguishing information.

2. The operating plan formulation support system, according to claim 1,
wherein the information processing device has:
a section that searches procedures already allocated to an operator for procedures of the second case by utilizing the distinguishing information, and
a section that allocates to the operator in parallel some of the procedures of another operation item that is different from the initially allocated operation item and implementable within the manipulating period of the initially allocated procedures.

3. The operating plan formulation support system, according to claim 2,
wherein the information processing device has:
a section that determines for the allocation that the number of experienced occasions of the operator for the allocated procedure and for the applicable ones of the procedures of the other operation item is not less than a certain level.

4. The operating plan formulation support system, according to claim 2,
wherein the information processing device has:
a section that, for the allocation, interrupts the allocated procedure, stores a switchover time necessary for implementing the applicable ones of the procedures of the other operation item, and determines whether or not it is possible to allocate the applicable ones of the procedures of the other operation item to the balance of subtracting the switchover time from the system action time.

5. The operating plan formulation support system, according to claim 2,
wherein the information processing device has:
a section that, for the allocation, interrupts the allocated procedure, generates a switchover time necessary for implementing the applicable ones of the procedures of the other operation item, and additionally allocates to the operator the switchover procedure.

6. The operating plan formulation support system, according to claim 1,
wherein the information processing device is provided with a display unit and, as a result of the allocation, presents to the operator already allocated manipulating procedures.

7. The operating plan formulation support system, according to claim 2,
wherein the information processing device is provided with a display unit and, when an already allocated manipulating procedure is to be presented to the operator as a result of the allocation, presents the part of the procedures of the other operation item to the operator after notifying the operator of the intended presentation of the applicable ones of the procedures.

8. The operating plan formulation support system, according to claim 4,
wherein the information processing device is provided with a display unit and, as a result of the allocation, presents the switchover procedure together with the presentation of the already allocated procedure.

9. An operating plan formulation support method for use by an operation management server to which an operation manager's terminal, at least one operator's terminal and a storage are connected,
wherein information for distinguishing whether a manipulating procedure is a first case in which a period of manipulation by an operator makes up a dominant part of a working period or a second case in which a period of system actions makes up a dominant part of the working period is stored, and allocation of the operation item is implemented by utilizing the distinguishing information.

10. The operating plan formulation support method according to claim 9,
wherein the procedures already allocated to an operator are searched via the operation manager's terminal for any procedure which is the second case, and some of the procedures of another operation item that can be implemented within the manipulating period of the procedure and is different from the initially allocated operation item is allocated to the operator in parallel.

11. The operating plan formulation support method according to claim 10,
wherein when an already allocated manipulating procedure is to be presented to the operator on the basis of a result of the allocation on a display unit, the applicable ones of the procedures of the other operation item is presented to the operator after notifying the operator of the intended presentation of the applicable ones of the procedures.
